(19) United States
(12) Patent Application Publication
(10) Pub. No.: US 2025/0140104 A1
(43) Pub. Date: May 1, 2025

(54) BUTTON CONTROL CIRCUIT, METHOD, DEVICE, STORAGE MEDIUM, AND REMOTE CONTROLLER

(71) Applicants: GREE ELECTRIC APPLIANCES, INC. OF ZHUHAI, Zhuhai (CN); EDGELESS SEMICONDUCTOR CO., LTD. OF ZHUHAI, Zhuhai (CN)

(72) Inventors: Yang LAN, Zhuhai (CN); Ji HE, Zhuhai (CN); Linfei HE, Zhuhai (CN); Baiyong ZANG, Zhuhai (CN)

(73) Assignees: GREE ELECTRIC APPLIANCES, INC. OF ZHUHAI, Zhuhai (CN); EDGELESS SEMICONDUCTOR CO., LTD. OF ZHUHAI, Zhuhai (CN)

(21) Appl. No.: 19/010,672

(22) Filed: Jan. 6, 2025

Related U.S. Application Data
(63) Continuation of application No. PCT/CN2023/089297, filed on Apr. 19, 2023.

(30) Foreign Application Priority Data
Jul. 6, 2022 (CN) 202210798279.7

(51) Int. Cl. G08C 19/00; H01H 9/54

(52) U.S. Cl. CPC G08C 19/00; H01H 9/54

(57) ABSTRACT

A button control circuit includes a button module, a power module, a control module, and a power supply control module. The button module is configured to simultaneously turn on a path between the power module and the control module and a button encoded signal trigger path when being operated. The control module is configured to start timing and output a first control signal to the power supply control module when obtaining a power signal in a power-off state. The first control signal is configured to control the power supply control module to be turned on, so as to supply power to the control module within a preset delay duration through the power module. The control module outputs a second control signal to the power supply control module when the button module is not operated within the preset delay duration.

### CROSS-REFERENCE TO RELATED APPLICATIONS

The present disclosure is a continuation of International Application No. PCT/CN2023/089297, filed on Apr. 19, 2023, which claims priority to Chinese Patent Application No. 202210798279.7, filed on Jul. 6, 2022. All of the aforementioned applications are incorporated herein by reference in their entireties.

### TECHNICAL FIELD

The present disclosure relates to the field of electronic technologies, and in particular, to a button control circuit, a button control method, an electronic device, a storage medium, and a remote controller.

### BACKGROUND

A standby power consumption problem of a remote controller is always a focus and difficulty of product design. Currently, when the remote controller is not operated, a main control chip in the remote controller is in a standby state, and when the remote controller is operated, the main control chip in the remote controller is in a normal working state. A low power consumption requirement of the remote controller may be met by reducing a standby power consumption of the main control chip in the remote controller.

Although the standby power consumption of the main control chip is relatively low, a power consumption of the remote controller is still generated in the standby state. However, the power consumption often occupies a large proportion in a life cycle of a battery of the remote controller. Therefore, how to solve the standby power consumption problem will determine an overall service life of the battery of a battery-powered remote controller.

### SUMMARY

The present disclosure provides a button control circuit, method and apparatus, a device, a storage medium, and a remote controller, to resolve a problem that power consumption of a remote controller is relatively large when the remote controller is in a standby state.

According to a first aspect, the present disclosure provides a button control circuit, which includes a button module, a power module, a control module, and a power supply control module. The power supply control module is connected between the power module and the control module, a control terminal of the control module is connected to a controlled terminal of the power supply control module, and an output terminal of the button module is connected to an input terminal of the control module. The button module is configured to simultaneously turn on a path between the power module and the control module and a button encoded signal trigger path when the button module is operated, the button encoded signal trigger path refers to a path between different input terminals of the control module, the path between the power module and the control module is configured to provide a power signal for the control module, and the button encoded signal trigger path is configured to output a button encoded signal to the control module. The control module is configured to start timing and output a first control signal to the power supply control module when obtaining the power signal in a power-off state, the first control signal being configured to control the power supply control module to be turned on, so as to supply power to the control module within a preset delay duration through the power module; and output a second control signal to the power supply control module when the button module is not operated within the preset delay duration, the second control signal being configured to control the power supply control module to be turned off, so that the power module stops supplying power to the control module.

Optionally, the control module is further configured to, when the button module is operated within the preset delay duration, receive a button encoded signal output by the button module, perform an operation corresponding to the button encoded signal, and restart timing.

Optionally, the power supply control module comprises a field effect transistor and a resistor. A first terminal of the power module is connected to a source electrode of the field effect transistor, and a second terminal of the power module is connected to a first terminal of the control module. A drain electrode of the field effect transistor is connected to a second terminal of the control module. The control terminal of the control module is connected to a gate electrode of the field effect transistor. A first terminal of the resistor is connected to the gate electrode of the field effect transistor, and a second terminal of the resistor is connected to the source electrode of the field effect transistor.

Optionally, the field effect transistor includes a p-channel metal oxide semiconductor (PMOS) transistor. A positive electrode of the power module is connected to the source electrode of the field effect transistor, and a negative electrode of the power module is connected to the first terminal of the control module.

Optionally, a first terminal of the button module is connected to the positive electrode of the power module, and a second terminal of the button module is connected to the second terminal of the control module.

Optionally, a first terminal of the button module is connected to the gate electrode of the field effect transistor, and a second terminal of the button module is connected to the negative electrode of the power module.

Optionally, the field effect transistor includes an n-channel metal oxide semiconductor (NMOS) transistor. A negative electrode of the power module is connected to the source electrode of the field effect transistor, and a positive electrode of the power module is connected to the first terminal of the control module.

Optionally, a first terminal of the button module is connected to the negative electrode of the power module, and a second terminal of the button module is connected to the second terminal of the control module.

Optionally, the button module includes a button matrix circuit, a bottom structure of at least one button in the button matrix circuit is provided with a first portion and a second portion that arranged to be separated, and a printed circuit board which is in contact with the bottom structure of the at least one button is provided with four contacts. When the at least one button is pressed, two contacts of the four contacts are in contact with the first portion, so that the two contacts are turned on to turn on the path between the power module and the control module; another two contacts of the four contacts are in contact with the second portion, so that the another two contacts are turned on to turn on the button encoded signal trigger path, thereby turning on the path between the power module and the control module and the button encoded signal trigger path simultaneously.

According to a second aspect, the present disclosure provides a remote controller, which includes the button control circuit according to the first aspect.

According to a third aspect, the present disclosure provides a button control method applied to a control module in the button control circuit according to the first aspect. The method includes: starting timing and outputting a first control signal to a power supply control module when obtaining a power signal in a power-off state, where the first control signal is configured to control the power supply control module to be turned on, so as to supply power to the control module within a preset delay duration through a power module; and outputting a second control signal to the power supply control module when the button module is not operated within the preset delay duration, where the second control signal is configured to control the power supply control module to be turned off, so that the power module stops supplying power to the control module.

Optionally, the button control method further includes: when the button module is operated within the preset delay duration, receiving a button encoded signal output by the button module, performing an operation corresponding to the button encoded signal, and restarting timing.

According to a fourth aspect, the present disclosure provides a button control apparatus configured in a control module in the button control circuit according to the first aspect. The apparatus includes: a first processing module, configured to start timing and output a first control signal to a power supply control module when obtaining a power signal in a power-off state, where the first control signal is configured to control the power supply control module to be turned on, so as to supply power to the control module within a preset delay duration through a power module; and a second processing module, configured to output a second control signal to the power supply control module when a button module is not operated within the preset delay duration, where the second control signal is configured to control the power supply control module to be turned off, so that the power module stops supplying power to the control module.

According to a fifth aspect, the present disclosure provides an electronic device, which includes: a processor, a memory, and a communication bus. The processor and the memory communicate with each other through the communication bus. The memory is configured to store a computer program. The processor is configured to execute the program stored in the memory to implement the button control method according to the third aspect.

According to a sixth aspect, the present disclosure provides a non-transitory computer-readable storage medium storing a computer program that, when executed by a processor, cause the processor to perform the button control method according to the third aspect.

Compared with a conventional technology, the above technical solution provided in the embodiments of the present disclosure has following advantages. A button control circuit provided in the embodiments of the present disclosure is provided with a power supply control module that is between a power module and a control module. The control module is in a power-off state during a standby state. When the button module is operated, a path between the power module and the control module and a button encoded signal trigger path can be turned on at the same time. The path between the power module and the control module can provide a power signal for the control module, and the button encoded signal trigger path can output a button encoded signal to the control module. Since the path between the power module and the control module and the button encoded signal trigger path are turned on at the same time, the control module is unable to receive the button encoded signal output by the button module when the button encoded signal trigger path is turned on. When the button module is operated, the path between the power module and the control module and the button encoded signal trigger path are turned on at the same time, so that the path between the power module and the control module and the button encoded signal trigger path do not interfere with each other, and an original function, outputting the button encoded signal to the control module, of the button module can be reserved.

When the control module obtains, in the power-off state, the power signal provided when the button module is operated, the control module controls the power supply control module to be turned on through a first control signal, so that the power module can supply power to the control module within the preset delay duration, to reserve the preset delay duration for the user. Therefore, after the control module is instantaneously energized, the user can have sufficient time to operate the button module to make the operation corresponding to the button encoded signal performed. Moreover, when the button module is not operated within the preset delay duration, the control module controls the power supply control module to be turned off through a second control signal, so that the power module stops supplying power to the control module, power is cut off in time, and power consumption of the control module is reduced. Therefore, zero power consumption of the control module in a standby state is achieved, and the problem that the power consumption of the remote controller is relatively large in the standby state is solved.

### BRIEF DESCRIPTION OF THE DRAWINGS

The accompanying drawings are incorporated into the specification and constitute a part of this specification, illustrating embodiments of the present disclosure and being configured to explain the principles of the present disclosure together with the description.

In order to more clearly illustrate the embodiments of the present disclosure or the technical solutions in the conventional technology, the drawings required in the description of the embodiments or the conventional technology will be briefly described below, and it is obvious to those skilled in the art that other drawings may be obtained according to these drawings without creative efforts.

FIG. 1 is a schematic structural diagram of a button control circuit according to an embodiment of the present disclosure.

FIG. 2 is a schematic structural diagram of a button control circuit according to a specific embodiment of the present disclosure.

FIG. 3 is a schematic structural diagram of a button module according to a specific embodiment of the present disclosure.

FIG. 4 is a schematic structural diagram of a button matrix circuit in a conventional technology.

FIG. 5 is a schematic structural diagram of a button module according to another specific embodiment of the present disclosure.

FIG. 6 is a schematic structural diagram of a button control circuit according to another specific embodiment of the present disclosure.

FIG. 7 is a schematic structural diagram of a button module according to another specific embodiment of the present disclosure.

FIG. 8 is a schematic diagram of a button according to a specific embodiment of the present disclosure.

FIG. 9 is a schematic diagram of a printed circuit board in contact with a bottom structure of a button according to a specific embodiment of the present disclosure.

FIG. 10 is a schematic flowchart of a button control method according to an embodiment of the present disclosure.

FIG. 11 is a schematic structural diagram of a button control apparatus according to an embodiment of the present disclosure.

FIG. 12 is a schematic structural diagram of an electronic device according to an embodiment of the present disclosure.

### DETAILED DESCRIPTION OF THE EMBODIMENTS

In order to make the objectives, technical solutions, and advantages of the embodiments of the present disclosure clearer, the following clearly describes the technical solutions in the embodiments of the present disclosure with reference to the accompanying drawings in the embodiments of the present disclosure. Obviously, the described embodiments are a portion of the embodiments of the present disclosure and not all of the embodiments. All other embodiments obtained by those skilled in the art based on the embodiments of the present disclosure without creative efforts shall fall within the protection scope of the present disclosure.

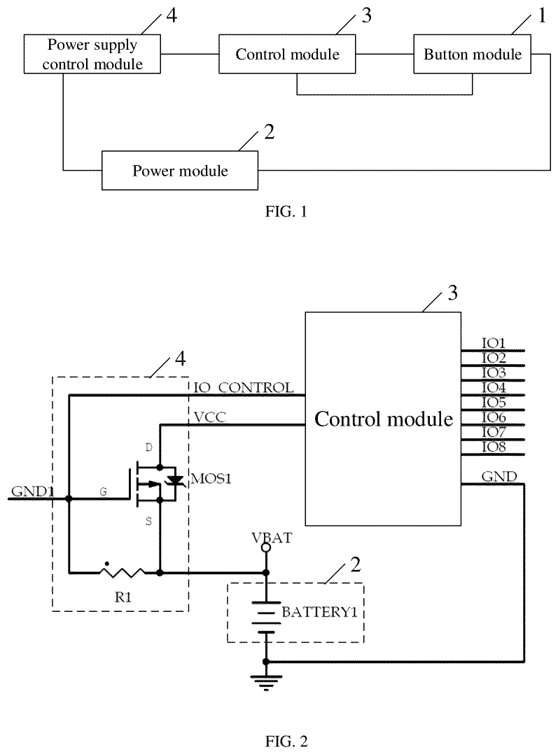

A button control circuit is provided according to an embodiment of the present disclosure. As shown in FIG. 1, the button control circuit includes a button module 1, a power module 2, a control module 3, and a power supply control module 4.

The power supply control module 4 is connected between the power module 2 and the control module 3. A control terminal of the control module 3 is connected to a controlled terminal of the power supply control module 4. An output terminal of the button module 1 is connected to an input terminal of the control module 3.

The output terminal of the button module 1 is connected to the input terminal of the control module 3, without changing a connection relationship between each button in the button module 1 and the control module 3, and without affecting the output button encoded signal of the button module, so as to realize a function of each button in the button module.

The button module 1 is configured to simultaneously turn on a path between the power module 2 and the control module 3 and a button encoded signal trigger path when the button module 1 is operated. The button encoded signal trigger path refers to a path between different input terminals of the control module 3. The path between the power module 2 and the control module 3 is configured to provide a power signal for the control module 3. The button encoded signal trigger path is configured to output a button encoded signal to the control module 3.

For example, a first output terminal of the button module 1 is connected to a first input terminal IO1 of the control module 3, a second output terminal of the button module 1 is connected to a second input terminal IO5 of the control module 3. The button encoded signal trigger path refers to a path between IO1 and IO5. When the button module 1 is operated, the path between the power module 2 and the control module 3 and the path between IO1 and IO5 are simultaneously turned on. Since the path between the power module and the control module and the button encoded signal trigger path are simultaneously turned on, the control module is unable to receive the button encoded signal output by the button module when the button encoded signal trigger path is turned on.

When the button module is operated, it may be that at least one button in the button module is pressed. When the button module is operated, the power supply control module is instantaneously turned on or short-circuited, so that the path between the power module and the control module is turned on, to provide an instantaneous power signal for the control module and make the control module be instantaneously energized.

The control module 3 is configured to start timing and output a first control signal to the power supply control module 4 when obtaining the power signal in a power-off state. The first control signal is configured to control the power supply control module 4 to be turned on, so as to supply power to the control module 3 within a preset delay duration through the power module 2. When the button module 1 is not operated within the preset delay duration, the control module 3 outputs a second control signal to the power supply control module 4. The second control signal is configured to control the power supply control module 4 to be turned off, so that the power module 2 stops supplying power to the control module 3.

The preset delay duration is a set duration between a moment when the button module is operated and a moment when the control module is power-off automatically. Different preset delay durations may be set according to usage habits of different remote controllers.

The control module 3 at least includes a button detection control module. The button detection control module can receive the button encoded signal output by the button module, and execute an operation corresponding to the button encoded signal to implement a normal function of the button module. The control module 3 may further include other modules according to a type of the remote controller. For example, the control module 3 may further include an infrared transmitting module of an infrared remote controller, a Bluetooth module of a Bluetooth remote controller, a liquid crystal display module of an air conditioner remote controller, a radio frequency transmitting module of a radio frequency remote controller, and the like. A power consumption of the remote controller in a standby state is further reduced.

By providing the power supply control module between the power module and the control module, the control module is in a power-off state during a standby state, and when the button module is operated, the path between the power module and the control module and the button encoded signal trigger path can be turned on simultaneously. The path between the power module and the control module can provide power signal for the control module, and the button encoded signal trigger path can output the button encoded signal to the control module. Since the path between the power module and the control module and the button encoded signal trigger path are turned on simultaneously, the control module is unable to receive the button encoded signal output by the button module when the button encoded signal trigger path is turned on. When the button module is operated, the path between the power module and the control module and the button encoded signal trigger path are turned on simultaneously, so that the path between the power module and the control module and the button encoded signal trigger path do not interfere with each other, and an original function, outputting the button encoded signal to the control module, of the button module can be reserved.

When the control module obtains, in the power-off state, the power signal provided when the button module is operated, the control module controls the power supply control module to be turned on through the first control signal, so that the power module can supply power to the control module within the preset delay duration, to reserve the preset delay duration for the user. Therefore, after the control module is instantaneously energized, the user can have sufficient time to operate the button module, to make the operation corresponding to the button encoded signal performed. Moreover, when the button module is not operated within the preset delay duration, the control module controls the power supply control module to be turned off through the second control signal, so that the power module stops supplying power to the control module, power is cut off in time, and power consumption of the control module is reduced. Therefore, zero power consumption of the control module in a standby state is achieved, and the problem that the power consumption of the remote controller is relatively large in the standby state is solved.

In a specific embodiment, the control module 3 is further configured to, when the button module 1 is operated within the preset delay duration, receive the button encoded signal output by the button module 1, perform an operation corresponding to the button encoded signal, and restart timing.

A normal function of the button module can be implemented. For example, within the preset delay duration, a volume increase button in the button module is pressed, and the control module performs a volume increase operation. A preset duration is reserved for the user, so that after the control module is instantaneously energized, the user can have sufficient time to operate the button module to make the operation corresponding to the button encoded signal performed.

Moreover, when the button module is operated within the preset delay duration, the control module restarts timing, so that the control module can be prevented from being powered off due to a fact that a duration between a moment when the button module is operated subsequently and a moment when the control module is instantaneously energized in a power-off state is greater than the preset delay duration in the process of the button module being operated multiple times, which need to re-operate the button module to enable the control module to be instantaneously energized, and operate the button module again to execute the operation corresponding to the button encoded signal, increasing operation steps, and affecting an use experience of the user.

In a specific embodiment, the power supply control module includes a field effect transistor and a resistor.

A first terminal of the power module is connected to a source electrode of the field effect transistor. A second terminal of the power module is connected to a first terminal of the control module. A drain electrode of the field effect transistor is connected to a second terminal of the control module. A control terminal of the control module is connected to a gate electrode of the field effect transistor. A first terminal of the resistor is connected to the gate electrode of the field effect transistor. A second terminal of the resistor is connected to the source electrode of the field effect transistor.

The field effect transistor is in a turned off state at a normal state, so that the control module is in a power-off state during a standby state, and zero power consumption of the control module in the standby state is achieved. The control terminal of the control module is connected to the gate electrode of the field effect transistor, and the field effect transistor is controlled to be turned on through the first control signal, which makes the control module keep an energized state to work normally. The field effect transistor is controlled to be turned off through the second control signal, which makes the control module to be powered off.

Specifically, the field effect transistor may be a field effect transistor with a turn-on voltage being less than a supply voltage of the power module and with extremely low on-resistance characteristics.

The first terminal of the resistor is connected to the gate electrode of the field effect transistor, and the second terminal of the resistor is connected to the source electrode of the field effect transistor, which can make the field effect transistor in a turned off state at a normal state, and also play a role in current limiting when the field effect transistor is turned on.

The power supply control module is added to an existing button control circuit, and the power supply control module includes the field effect transistor and the resistor, so that the number of newly added electronic components is small and a cost is low.

In a specific embodiment, as shown in FIG. 2, a power supply control module 4 includes a field effect transistor and a resistor R1, the field effect transistor is a PMOS transistor MOS1. In FIG. 2, the power module 2 is represented by BATTERY1, which represents the power module 2 is a battery. In FIG. 2, a gate electrode G of the field effect transistor MOS1 is represented by GND1.

A positive electrode VBAT of the power module 2 is connected to a source electrode S of the field effect transistor MOS1. A negative electrode of the power module 2 is connected to a first terminal GND of the control module 3. The negative electrode of the power module 2 is grounded. A drain electrode D of the field effect transistor MOS1 is connected to a second terminal VCC of the control module 3. A control terminal IO CONTROL of the control module 3 is connected to the gate electrode G of the field effect transistor MOS1. A first terminal of the resistor R1 is connected to the gate electrode G of the field effect transistor MOS1. A second terminal of the resistor R1 is connected to the source electrode S of the field effect transistor MOS1. In FIG. 2, IO1 to IO8 are input terminals of the control module 3, and are configured to be connected to an output terminal of a button module 1. The number of the input terminals of the control module 3 in FIG. 2 is only illustrative and does not limit a specific number of input terminals of the control module 3.

In a standby state, the PMOS transistor MOS1 is in a turned off state, and a connection between the positive electrode VBAT of the power module 2 and the second terminal VCC of the control module 3 is cut off through the PMOS transistor MOS1, so that the control module is in a power-off state during the standby state, and zero power consumption of the control module in the standby state is achieved.

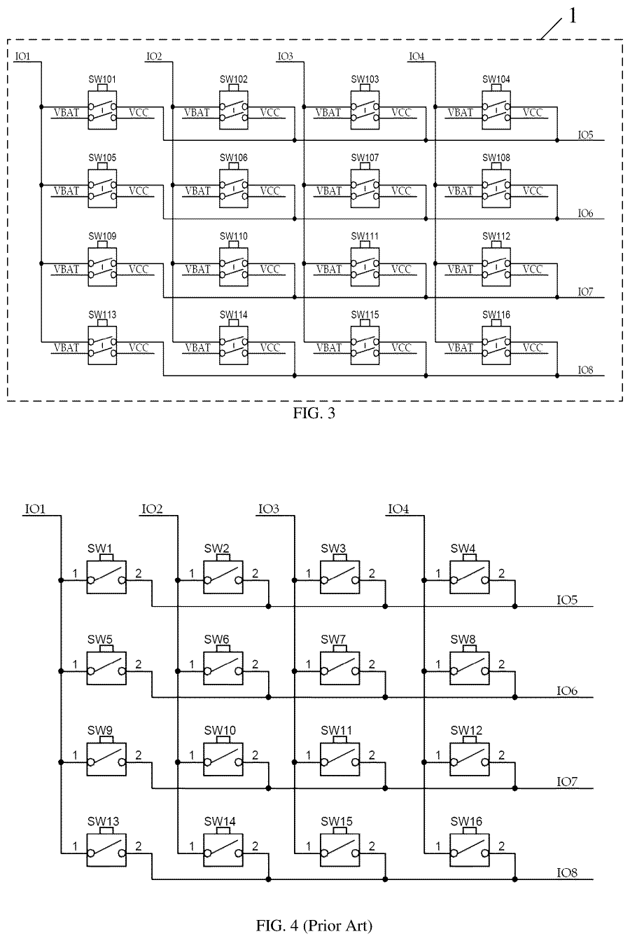

In a specific embodiment, as shown in FIG. 2 and FIG. 3, a first terminal of the button module 1 is connected to the positive electrode VBAT of the power module 2, and a second terminal of the button module 1 is connected to the second terminal VCC of the control module 3. In FIG. 3, the button module 1 is a button matrix circuit and includes 16 buttons, i.e., SW101 to SW116. The IO1 to IO8 are input terminals of the control module 3, which are configured to be connected to an output terminal of the button module 1. Triggers of functions of the 16 different buttons are realized through the 8 input terminals of the control module 3, which can save the number of input terminals of the control module 3. In FIG. 3, the number of the input terminals of the control module 3 is only schematic, and a specific number of the input terminals of the control module 3 is not limited. The number of the buttons is only schematic, and a specific number of the buttons is not limited.

In FIG. 3, a first terminal of each button is connected to the positive electrode VBAT of the power module 2, and a second terminal of each button is connected to the second terminal VCC of the control module 3. A function of pressing any button to wake up a remote controller can be achieved. According to needs, it is not necessary to add the first terminal and the second terminal for each button, while the first terminal of each button is connected to the positive electrode VBAT of the power module 2, and the second terminal of each button is connected to the second terminal VCC of the control module 3. As long as at least one of the buttons of the button module 1 is added with the first terminal and the second terminal, while the first terminal is connected to the positive electrode VBAT of the power module 2 and the second terminal is connected to the second terminal VCC of the control module 3, it can realize that when the button module is operated, the power supply control module is instantaneously short-circuited and a path between the power module and the control module is turned on, to provide an instantaneous power signal for the control module, and make the control module be instantaneously energized.

In FIG. 3, when the button module is operated, a path between the positive electrode VBAT of the power module 2 and the second terminal VCC of the control module 3 is directly turned on, and the control module is instantaneously energized. After the control module is instantaneously energized, the control module outputs a first control signal to a gate electrode G of the field effect transistor MOS1. The first control signal is at a low level, the field effect transistor MOS1 is turned on, and the control module is maintained in a state of being energized.

On a basis of FIG. 2 and FIG. 3, after the control module is instantaneously energized, the control module outputs the first control signal to the gate electrode G of the field effect transistor MOS1. The first control signal is at a low level. The field effect transistor MOS1 is turned on. The control module is maintained in a state of being energized within a preset delay duration, receives a button encoded signal output by the button module, performs an operation corresponding to the button encoded signal, and restarts timing. When the button module is not operated within the preset delay duration, the control module outputs a second control signal to the gate electrode G of the field effect transistor MOS1. The second control signal is at a high level, the field effect transistor MOS1 is turned off, and the control module is powered off and enters a standby mode without power consumption.

In FIG. 3, an explanation is illustrated with a button SW101 being pressed. When the button SW101 is pressed, a path between IO1 and IO5 and a path between the positive electrode VBAT of the power module 2 and the second terminal VCC of the control module 3 are instantaneously turned on at a same time. When the path between the positive electrode VBAT of the power module 2 and the second terminal VCC of the control module 3 is turned on, the control module is instantaneously energized. When the path between IO1 and IO5 is turned on, a button encoded signal corresponding to the button SW101 is output. The control module can only receive the button encoded signal corresponding to the button SW101 after the control module is energized. However, when the two paths are turned on at the same time, the control module is unable to receive the button encoded signal corresponding to the button SW101, so as to avoid the control module mistakenly executing operations corresponding to the button encoded signal when the button SW101 is pressed to make the control module to be energized.

The applicant finds that in the conventional technology, as shown in FIG. 4, a button matrix circuit includes 16 buttons, i.e., SW1 to SW16, and IO1 to IO8 are input terminals of the control module, which are configured to be connected to an output terminal of the button matrix circuit. Triggers of functions of the 16 different buttons are realized by the 8 input terminals of the control module, which can save the number of input terminals of the control module. However, a bottom structure of each button in SW1 to SW16 is an integral structure, and a printed circuit board which is in contact with each button is provided with two contacts. When the button is pressed, the two contacts are in contact with the bottom structure of the button to achieve a conduction between the two contacts, so that only the button encoded signal corresponding to the button can be output, and the control module cannot be energized instantaneously.

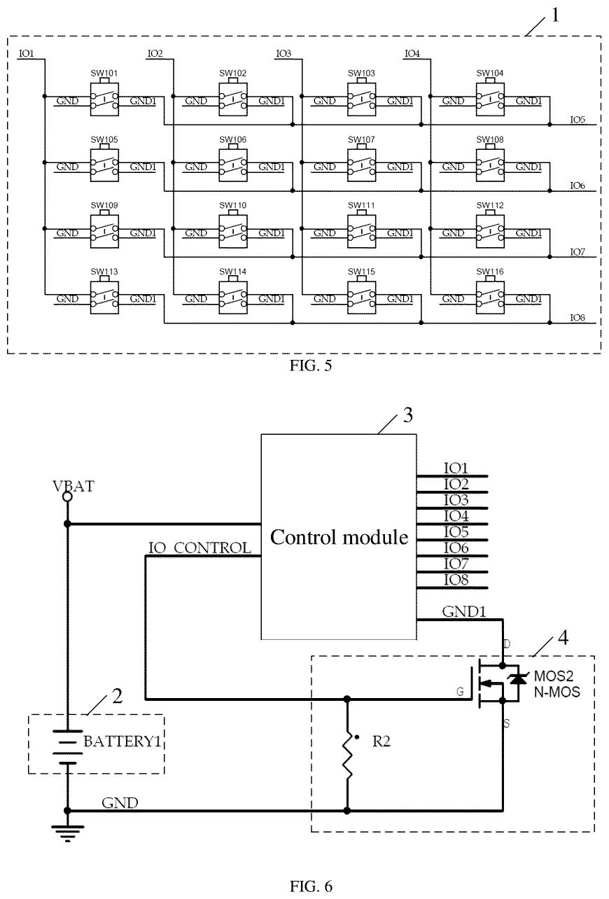

In a specific embodiment, as shown in FIG. 2 and FIG. 5, the first terminal of the button module 1 is connected to the gate electrode G of the field effect transistor MOS1. The gate electrode G of the field effect transistor MOS1 is represented by GND1. The second terminal of the button module 1 is connected to a negative electrode GND of the power module 2. In FIG. 5, the button module 1 is a button matrix circuit and includes 16 buttons, i.e., SW101 to SW116. IO1 to IO8 are input terminals of the control module 3, which are configured to be connected to an output terminal of the button module 1. Triggers of functions of the 16 different buttons are realized by the 8 input terminals of the control module 3, which can save the number of input terminals of the control module 3. In FIG. 5, the number of the input terminals of the control module 3 is only schematic, and a specific number of the input terminals of the control module 3 is not limited. The number of the buttons is only schematic, and a specific number of the buttons is not limited.

In FIG. 5, the first terminal of each button is connected to the gate electrode G of the field effect transistor MOS1, and a second terminal of each button is connected to the negative electrode GND of the power module 2. A function of pressing any button to wake up a remote controller can be achieved. According to needs, it is not necessary to add the first terminal and the second terminal for each button, while the first terminal of each button is connected to the gate electrode G of the field effect transistor MOS1, and the second terminal of each button is connected to the negative electrode GND of the power module 2. As long as at least one of the buttons of the button module 1 is added with the first terminal and the second terminal, while the first terminal is connected to the gate electrode G of the field effect transistor MOS1 and the second terminal is connected to the negative electrode GND of the power module 2, it can realize that when the button module is operated, the power supply control module is instantaneously turned on and a path between the power module and the control module is turned on, to provide an instantaneous power signal for the control module, and make the control module be instantaneously energized.

In FIG. 5, when the button module is operated, a path between the negative electrode GND of the power module 2 and the gate electrode G of the field effect transistor MOS1 is directly turned on, the field effect transistor MOS1 is instantaneously turned on, then the control module is instantaneously energized. After the control module is instantaneously energized, the control module outputs a first control signal to the gate electrode G of the field effect transistor MOS1. The first control signal is at a low level, the field effect transistor MOS1 is turned on, and the control module is maintained in a state of being energized.

On a basis of FIG. 2 and FIG. 5, after the control module is instantaneously energized, the control module outputs the first control signal to the gate electrode G of the field effect transistor MOS1. The first control signal is at a low level. The field effect transistor MOS1 is turned on. The control module is maintained in a state of being energized within a preset delay duration, receives a button encoded signal output by the button module, performs an operation corresponding to the button encoded signal, and restarts timing. When the button module is not operated within the preset delay duration, the control module outputs a second control signal to the gate electrode G of the field effect transistor MOS1. The second control signal is at a high level, the field effect transistor MOS1 is turned off, and the control module is powered off and enters a standby mode without power consumption.

In FIG. 5, an explanation is illustrated with a button SW101 being pressed. When the button SW101 is pressed, a path between IO1 and IO5 and a path between the negative electrode GND of the power module 2 and the gate electrode G of the field effect transistor MOS1 are instantaneously turned on at a same time. When the path between the negative electrode GND of the power module 2 and the gate electrode G of the field effect transistor MOS1 is turned on, the control module is instantaneously energized. When the path between IO1 and IO5 is turned on, the button encoded signal corresponding to the button SW101 is output. The control module can only receive the button encoded signal corresponding to the button SW101 after the control module is energized. However, when the two paths turned on at the same time, the control module is unable to receive the button encoded signal corresponding to the button SW101, so as to avoid the control module mistakenly executing operations corresponding to the button encoded signal when the button SW101 is pressed to make the control module to be energized.

In a specific embodiment, as shown in FIG. 6, a power supply control module 4 includes a field effect transistor and a resistor R2, and the field effect transistor is an NMOS transistor MOS2. In FIG. 6, a power module 2 is represented by BATTERY1, which represents the power module 2 is a battery.

A negative electrode GND of the power module 2 is connected to a source electrode S of the field effect transistor MOS2, the negative electrode of the power module 2 is grounded, and a positive electrode VBAT of the power module 2 is connected to a first terminal of a control module 3. A drain electrode D of the field effect transistor MOS2 is connected to a second terminal GND1 of the control module 3. A control terminal IO CONTROL of the control module 3 is connected to a gate electrode G of the field effect transistor MOS2. A first terminal of the resistor R2 is connected to the gate electrode G of the field effect transistor MOS2. A second terminal of the resistor R2 is connected to the source electrode S of the field effect transistor MOS2. In FIG. 6, IO1 to IO8 are input terminals of the control module 3, which is configured to be connected to an output terminal of a button module 1. The number of the input terminals of the control module 3 in FIG. 6 is only schematic, and a specific number of the input terminals of the control module 3 is not limited.

In a standby state, the NMOS transistor MOS2 is in a turned off state, and a connection between the negative electrode GND of the power module 2 and the second terminal GND1 of the control module 3 is cut off through the NMOS transistor MOS2, so that the control module is in a power-off state during the standby state, and zero power consumption of the control module in the standby state is achieved.

In a specific embodiment, as shown in FIG. 6 and FIG. 7, a first terminal of the button module 1 is connected to the negative electrode GND of the power module 2, and a second terminal of the button module is connected to the second terminal GND1 of the control module 3. In FIG. 7, the button module 1 is a button matrix circuit, the button module 1 includes 16 buttons, i.e., SW101 to SW116. IO1 to IO8 are input terminals of the control module 3, which are configured to be connected to the output terminal of the button module 1. Triggers of functions of the 16 different buttons are realized by the 8 input terminals of the control module 3, which can save the number of input terminals of the control module 3. In FIG. 7, the number of the input terminals of the control module 3 is only schematic, and a specific number of the input terminals of the control module 3 is not limited. The number of the buttons is only schematic, and a specific number of the buttons is not limited.

In FIG. 7, a first terminal of each button is connected to the negative electrode GND of the power module 2, and a second terminal of each button is connected to the second terminal GND1 of the control module 3. A function of pressing any button to wake up a remote controller can be achieved. According to needs, it is not necessary to add the first terminal and the second terminal for each button, while the first terminal of each button is connected to the negative electrode GND of the power module 2, and the second terminal of each button is connected to the second terminal GND1 of the control module 3. As long as at least one of the buttons of the button module 1 is added with the first terminal and the second terminal, while the first terminal is connected to the negative electrode GND of the power module 2 and the second terminal is connected to the second terminal GND1 of the control module 3, it can realize that when the button module is operated, the power supply control module is instantaneously short-circuited and a path between the power module and the control module is turned on, to provide an instantaneous power signal for the control module, and make the control module be instantaneously energized.

In FIG. 7, when the button module is operated, a path between the negative electrode GND of the power module 2 and the second terminal GND1 of the control module 3 is directly turned on, and the control module is instantaneously energized. After the control module is instantaneously energized, the control module outputs a first control signal to a gate electrode G of the field effect transistor MOS2. The first control signal is at a high level, the field effect transistor MOS2 is turned on, and the control module is maintained in a state of being energized.

On a basis of FIG. 6 and FIG. 7, after the control module is instantaneously energized, the control module outputs the first control signal to the gate electrode G of the field effect transistor MOS2. The first control signal is at a high level. The field effect transistor MOS2 is turned on. The control module is maintained in a state of being energized within a preset delay duration, receives a button encoded signal output by the button module, performs an operation corresponding to the button encoded signal, and restarts timing. When the button module is not operated within the preset delay duration, the control module outputs a second control signal to the gate electrode G of the field effect transistor MOS2. The second control signal is at a low level, the field effect transistor MOS2 is turned off, and the control module is powered off and in a standby mode without power consumption.

In FIG. 7, an explanation is illustrated with a button SW101 being pressed. When the button SW101 is pressed, a path between IO1 and IO5 and a path between the negative electrode GND of the power module 2 and the second terminal GND1 of the control module 3 are instantaneously turned on at a same time. When the path between the negative electrode GND of the power module 2 and the second terminal GND1 of the control module 3 is turned on, the control module is instantaneously energized. When the path between IO1 and IO5 is turned on, the button encoded signal corresponding to the button SW101 is output. The control module can only receive the button encoded signal corresponding to the button SW101 after the control module is energized. However, when the two paths turned on at the same time, the control module is unable to receive the button encoded signal corresponding to the button SW101, so as to avoid the control module mistakenly executing operations corresponding to the button encoded signal when the button SW101 is pressed to make the control module to be energized.

In a specific embodiment, the button module includes a button matrix circuit. The number of buttons in the button matrix circuit is greater than the number of output terminals of the button matrix circuit. As shown in FIG. 3, the button module 1 is a button matrix circuit and includes 16 buttons, i.e., SW101 to SW116. IO1 to IO8 are input terminals of the control module 3, which are configured to be connected to an output terminal of the button module 1. Triggers of functions of the 16 different buttons are realized by the 8 input terminals of the control module 3, and the number of buttons in the button matrix circuit is greater than the number of output terminals of the button matrix circuit, which can save the number of input terminals of the control module 3. In FIG. 3, the number of the input terminals of the control module 3 is only schematic, and a specific number of the input terminals of the control module 3 is not limited. The number of the buttons is only schematic, and a specific number of the buttons is not limited.

A bottom structure of at least one button in the button matrix circuit is provided with a first portion and a second portion that arranged to be separated, and a printed circuit board which is in contact with the bottom structure of the at least one button is provided with four contacts. When the at least one button is pressed, two contacts of the four contacts are in contact with the first portion, so that the two contacts are turned on to turn on the path between the power module and the control module; and another two contacts of the four contacts are in contact with the second portion, so that the another two contacts are turned on to turn on the button encoded signal trigger path, thereby turning on the path between the power module and the control module and the button encoded signal trigger path simultaneously.

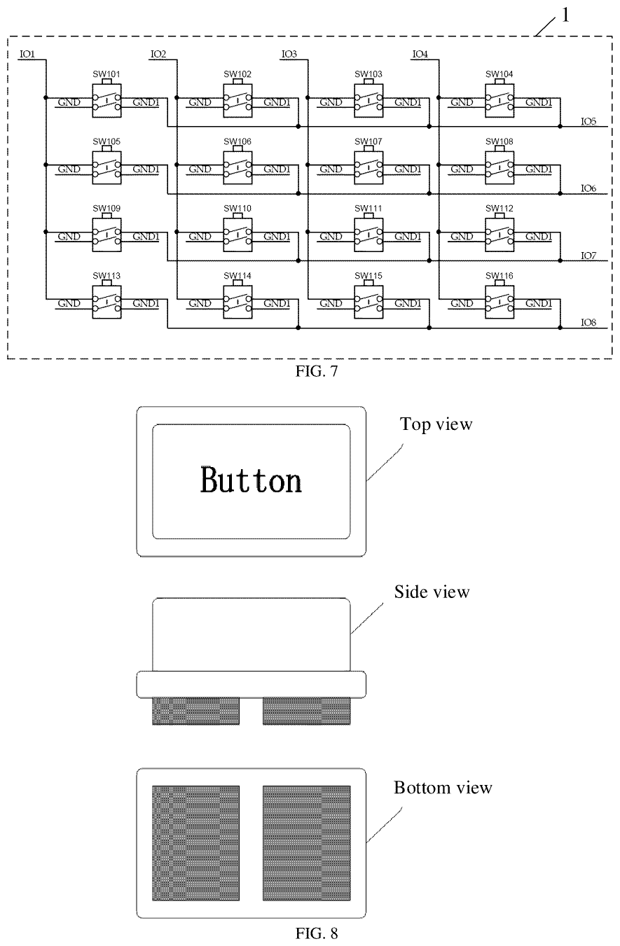

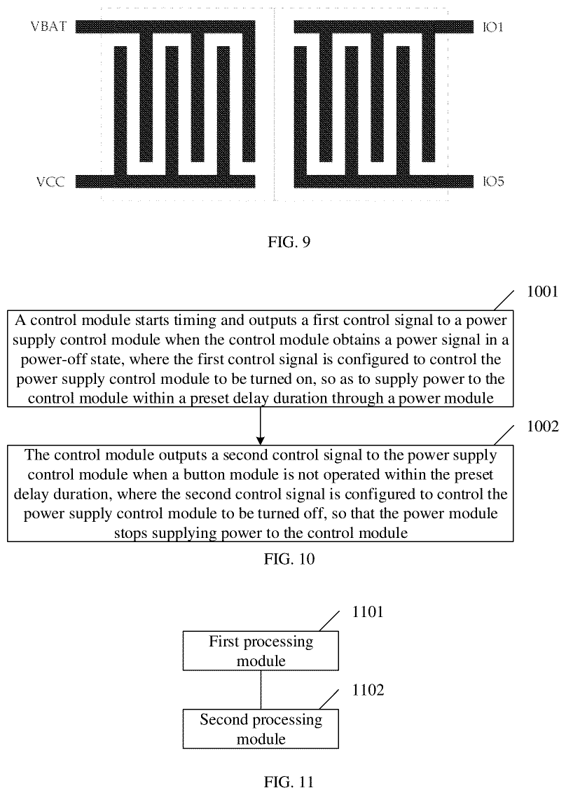

As shown in FIG. 8, a top view, a side view, and a bottom view of the button are shown. There is a word “Button” on the top view. According to the side view and the bottom view, the bottom structure of the button has a first portion and a second portion that arranged to be separated. A lower surface of the first portion is provided with a graphite coating, a lower surface of the second part is provided with a graphite coating, and an electrical conduction between contacts on the printed circuit board is realized through the graphite coating. As shown in FIG. 9, a printed circuit board which is in contact with the bottom structure of the button is provided with four contacts VBAT, VCC, IO1 and IO5, and the printed circuit board which is in contact with the bottom structure of the button is provided with an exposed copper foil with a comb structure. The contact VBAT and the contact VCC correspond to a pair of comb cross-winding which is formed by two comb windings, and the contacts IO1 and the contacts IO5 correspond to a pair of comb cross-winding which is formed by two comb windings. Two pairs of comb cross-windings are formed by the four contacts, and the two pairs of comb cross-winding do not interfere with each other.

In the conventional technology, a design of a remote controller does not need to mount a physical button on a printed circuit board, but only need to design an exposed copper foil with a comb structure on the printed circuit board, so that an electrical conduction is achieved through a graphite coating that located on a lower surface of a colloid button when a one-piece rebound colloid button on a top of the exposed copper foil is pressed. In the conventional technology, a bottom structure of the button is arranged as an integral structure, the graphite coating on the lower surface of the colloid button is also an entirety, the printed circuit board which is in contact with the bottom structure of the button is provided with two contacts, which correspond to a pair of comb cross-winding formed by two comb windings, and only a conduction between two contacts can be achieved. However, in FIG. 8 and FIG. 9, the bottom structure of the button is provided with a first portion and a second portion that arranged to be separated, and the printed circuit board which is in contact with the bottom structure of the button is provided with four contacts, so that one button can control four contacts to turn on two paths. In FIG. 8 and FIG. 9, when the button is pressed, the contact VBAT and the contact VCC are turned on to turn on the path between the power module and the control module, the contact IO1 and the contact IO5 are turned on to turn on the button encoded signal trigger path, so that the path between the power module and the control module and the button encoded signal trigger path are turned on simultaneously. The path between the contact VBAT and the contact VCC does not interfere with the path between the contact IO1 and the contact IO5, thereby implementing a one-button dual-control function. Moreover, FIG. 8 and FIG. 9 only change a shape of the bottom structure of the button and a shape of a contact copper foil on the printed circuit board, and do not increase a material cost.

Based on a same concept, a remote controller is provided according to embodiments of the present disclosure. The remote controller includes the button control circuit provided in the embodiments of the present disclosure.

Based on a same concept, a button control method is provided according to embodiments of the present disclosure. The button control method is applied to the control module in the button control circuit provided in embodiments of the present disclosure. As shown in FIG. 10, the button control method mainly includes the following contents.

In Step 1001, the control module starts timing and outputs a first control signal to a power supply control module when the control module obtains a power signal in a power-off state, where the first control signal is configured to control the power supply control module to be turned on, so as to supply power to the control module within a preset delay duration through a power module.

The preset delay duration is a set duration between a moment when the button module is operated and a moment when the control module is power-off automatically. Different preset delay durations may be set according to usage habits for different remote controllers.

Step 1002: the control module outputs a second control signal to the power supply control module when a button module is not operated within the preset delay duration, where the second control signal is configured to control the power supply control module to be turned off, so that the power module stops supplying power to the control module.

When the control module obtains, in the power-off state, the power signal provided when the button module is operated, the control module controls the power supply control module to be turned on through the first control signal, so that the power module can supply power to the control module within the preset delay duration, to reserve the preset delay duration for the user. Therefore, after the control module is instantaneously energized, the user can have sufficient time to operate the button module, to make the operation corresponding to the button encoded signal performed. Moreover, when the button module is not operated within the preset delay duration, the control module controls the power supply control module to be turned off through the second control signal, so that the power module stops supplying power to the control module, power is cut off in time, and power consumption of the control module is reduced. Therefore, zero power consumption of the control module in a standby state is achieved, and the problem that the power consumption of the remote controller is relatively large in the standby state is solved.

In a specific embodiment, the button control method further includes: when the button module is operated within the preset delay duration, the control module receives a button encoded signal output by the button module, performs an operation corresponding to the button encoded signal, and restarts timing.

A normal function of the button module can be implemented. For example, within the preset delay duration, a volume increase button in the button module is pressed, and the control module performs a volume increase operation. A preset duration is reserved for the user, and after the control module is instantaneously energized, the user can have sufficient time to operate the button module, to make the operation corresponding to the button encoded signal performed.

Moreover, when the button module is operated within the preset delay duration, the control module restarts timing, so that the control module can be prevented from being powered off due to a fact that a duration between a moment when the button module is operated subsequently and a moment when the control module is instantaneously energized in a power-off state is greater than the preset delay duration in the process of the button module being operated multiple times, which need to re-operate the button module to enable the control module to be instantaneously energized, and operate the button module again to execute the operation corresponding to the button encoded signal, increasing operation steps, and affecting an use experience of the user.

Based on a same concept, a button control apparatus is provided according to embodiments of the present disclosure. The button control apparatus is configured in the control module in the button control circuit provided according to embodiments of the present disclosure. For a specific implementation of the button control apparatus, please refer to the description of the embodiments for the button control method, and details are not described herein again. As shown in FIG. 11, the button control apparatus mainly includes a first processing module 1101 and a second processing module 1102.

The first processing module 1101 is configured to start timing and output a first control signal to a power supply control module when obtaining a power signal in a power-off state, where the first control signal is configured to control the power supply control module to be turned on, so as to supply power to the control module within a preset delay duration through a power module.

The second processing module 1102 is configured to output a second control signal to the power supply control module when a button module is not operated within the preset delay duration, where the second control signal is configured to control the power supply control module to be turned off, so that the power module stops supplying power to the control module.

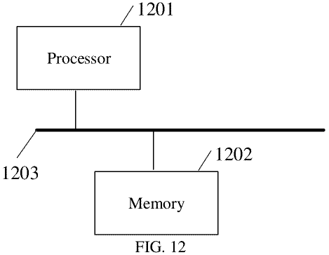

Based on a same concept, an electronic device is further provided according to embodiments of the present disclosure. As shown in FIG. 12, the electronic device mainly includes a processor 1201, a memory 1202, and a communications bus 1203. The processor 1201 and the memory 1202 communicate with each other through the communications bus 1203. The memory 1202 stores a program that can be executed by the processor 1201, and the processor 1201 is configured to execute the program stored in the memory 1202 to implement the following steps: starting timing and outputting a first control signal to a power supply control module when obtaining a power signal in a power-off state, where the first control signal is configured to control the power supply control module to be turned on, so as to supply power to the control module within a preset delay duration through a power module; outputting a second control signal to the power supply control module when a button module is not operated within the preset delay duration, where the second control signal is configured to control the power supply control module to be turned off, so that the power module stops supplying power to the control module.

The communication bus 1203 mentioned in the electronic device may be a Peripheral Component Interconnect (PCI) bus or an Extended Industry Standard Architecture (EISA) bus, or the like. The communications bus 1203 may be classified into an address bus, a data bus, a control bus, and the like. For ease of representation, only one thick line is used to represent the bus in FIG. 12, but it does not mean that there is only one bus or one type of bus.

The memory 1202 may include a Random Access Memory (RAM), or may include a non-volatile Memory, for example, at least one magnetic disk memory. Optionally, the memory may also be at least one storage apparatus located away from the processor 1201.

The processor 1201 may be a general-purpose processor, including a Central Processing Unit (CPU), a Network Processor (NP), or the like, or may be a Digital Signal Processing (DSP), an Application Specific Integrated Circuit (ASIC), a Field-Programmable Gate Array (FPGA) or another programmable logic device, a discrete gate or a transistor logic device, or a discrete hardware component.

In another embodiment of the present disclosure, a computer-readable storage medium is further provided, where a computer program is stored in the computer-readable storage medium, and when the computer program runs on a computer, the computer is enabled to perform the button control method described in the foregoing embodiments.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, computer instructions are transmitted from a website, a computer, a server, or a data center to another website, computer, server, or data center in a wired (for example, coaxial cable, optical fiber, Digital Subscriber Line (DSL)), or wireless (for example, infrared, microwave, and the like) manner. The computer-readable storage medium may be any usable medium accessible by a computer, or a data storage device including a server or a data center that may be integrated through one or more usable mediums. The usable medium may be a magnetic medium (for example, a floppy disk, a hard disk, or a magnetic tape), an optical medium (for example, a Digital Video Disk (DVD)), a semiconductor medium (for example, a solid-state disk), or the like.

It should be noted that, in this specification, relational terms such as “first” and “second” are merely used to distinguish one entity or operation from another entity or operation, and do not necessarily require or imply that any actual relationship or sequence exists between these entities or operations. Moreover, the terms “comprising”, “including”, or any other variation thereof are intended to cover a non-exclusive inclusion, so that a process, method, article, or device that includes a series of elements includes not only those elements, but also other elements that are not explicitly listed, or elements inherent to such a process, method, article, or device. Without further limitation, an element limited by the statement “including one” does not exclude the existence of another identical element in the process, method, article or device that includes the foregoing statement.

The foregoing descriptions are merely specific implementations of the present disclosure, to enable those skilled in the art to understand or implement the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but is to be accorded the widest scope consistent with the principles and novel features disclosed herein.

What is claimed is:

1. A button control circuit, comprising a button module, a power module, a control module, and a power supply control module;
wherein the power supply control module is connected between the power module and the control module, a control terminal of the control module is connected to a controlled terminal of the power supply control module, and an output terminal of the button module is connected to an input terminal of the control module;
the button module is configured to simultaneously turn on a path between the power module and the control module and a button encoded signal trigger path when the button module is operated, the button encoded signal trigger path refers to a path between different input terminals of the control module, the path between the power module and the control module is configured to provide a power signal for the control module, and the button encoded signal trigger path is configured to output a button encoded signal to the control module; and
the control module is configured to start timing and output a first control signal to the power supply control module when obtaining the power signal in a power-off state, the first control signal is configured to control the power supply control module to be turned on, so as to supply power to the control module within a preset delay duration through the power module; and output a second control signal to the power supply control module when the button module is not operated within the preset delay duration, the second control signal is configured to control the power supply control module to be turned off, so that the power module stops supplying power to the control module.

2. The button control circuit according to claim 1, wherein the control module is further configured to, when the button module is operated within the preset delay duration, receive a button encoded signal output by the button module, perform an operation corresponding to the button encoded signal, and restart timing.

3. The button control circuit according to claim 1, wherein the power supply control module comprises a field effect transistor and a resistor; and
a first terminal of the power module is connected to a source electrode of the field effect transistor, a second terminal of the power module is connected to a first terminal of the control module, a drain electrode of the field effect transistor is connected to a second terminal of the control module, the control terminal of the control module is connected to a gate electrode of the field effect transistor, a first terminal of the resistor is connected to the gate electrode of the field effect transistor, and a second terminal of the resistor is connected to the source electrode of the field effect transistor.

4. The button control circuit according to claim 3, wherein the field effect transistor comprises a p-channel metal oxide semiconductor (PMOS) transistor; and
a positive electrode of the power module is connected to the source electrode of the field effect transistor, and a negative electrode of the power module is connected to the first terminal of the control module.

5. The button control circuit according to claim 4, wherein a first terminal of the button module is connected to the positive electrode of the power module, and a second terminal of the button module is connected to the second terminal of the control module.

6. The button control circuit according to claim 4, wherein a first terminal of the button module is connected to the gate electrode of the field effect transistor, and a second terminal of the button module is connected to the negative electrode of the power module.

7. The button control circuit according to claim 3, wherein the field effect transistor comprises an n-channel metal oxide semiconductor (NMOS) transistor; and
a negative electrode of the power module is connected to the source electrode of the field effect transistor, and a positive electrode of the power module is connected to the first terminal of the control module.

8. The button control circuit according to claim 7, wherein a first terminal of the button module is connected to the negative electrode of the power module, and a second terminal of the button module is connected to the second terminal of the control module.

9. The button control circuit according to claim 1, wherein the button module comprises a button matrix circuit, a bottom structure of at least one button in the button matrix circuit is provided with a first portion and a second portion that are separated, and a printed circuit board which is in contact with the bottom structure of the at least one button is provided with four contacts, when the at least one button is pressed, two contacts of the four contacts are in contact with the first portion, so that the two contacts are turned on to turn on the path between the power module and the control module, another two contacts of the four contacts are in contact with the second portion, so that the another two contacts are turned on to turn on the button encoded signal trigger path, thereby turning on the path between the power module and the control module and the button encoded signal trigger path simultaneously.

10. A remote controller, comprising the button control circuit according to claim 1.

11. A button control method, applied to a control module in the button control circuit according to claim 1, comprising:
starting timing and outputting a first control signal to a power supply control module when obtaining a power signal in a power-off state, the first control signal being configured to control the power supply control module to be turned on, so as to supply power to the control module within a preset delay duration through a power module; and
outputting a second control signal to the power supply control module when a button module is not operated within the preset delay duration, wherein the second control signal is configured to control the power supply control module to be turned off, so that the power module stops supplying power to the control module.

12. The button control method according to claim 11, further comprising:
when the button module is operated within the preset delay duration, receiving a button encoded signal output by the button module, performing an operation corresponding to the button encoded signal, and restarting timing.

13. An electronic device, comprising: a processor, a memory, and a communication bus, wherein the processor and the memory communicate with each other through the communication bus;
the memory is configured to store a computer program; and
the processor is configured to execute the program stored in the memory to implement a button control method, the method comprising:
starting timing and outputting a first control signal to a power supply control module when obtaining a power signal in a power-off state, the first control signal being configured to control the power supply control module to be turned on, so as to supply power to the control module within a preset delay duration through a power module; and
outputting a second control signal to the power supply control module when a button module is not operated within the preset delay duration, wherein the second control signal is configured to control the power supply control module to be turned off, so that the power module stops supplying power to the control module.

14. The electronic device according to claim 13, wherein the method further comprises:
when the button module is operated within the preset delay duration, receiving a button encoded signal output by the button module, performing an operation corresponding to the button encoded signal, and restarting timing.

15. A non-transitory computer-readable storage medium, storing a computer program that, when executed by a processor, cause the processor to perform a button control method, the method comprising:
starting timing and outputting a first control signal to a power supply control module when obtaining a power signal in a power-off state, the first control signal being configured to control the power supply control module to be turned on, so as to supply power to the control module within a preset delay duration through a power module; and
outputting a second control signal to the power supply control module when a button module is not operated within the preset delay duration, wherein the second control signal is configured to control the power supply control module to be turned off, so that the power module stops supplying power to the control module.

16. The storage medium according to claim 15, wherein the method further comprises:
when the button module is operated within the preset delay duration, receiving a button encoded signal output by the button module, performing an operation corresponding to the button encoded signal, and restarting timing.
